(19) United States
(12) Patent Application Publication
(10) Pub. No.: US 2004/0137158 A1
(43) Pub. Date: Jul. 15, 2004

(54) Method for preparing a noble metal surface

(76) Inventors: Jacques Constant Stefan Kools, Sunnyvale, CA (US); Kurt Edwin Williams, Seaford, NY (US); David Joseph Metacarpa SR., Rochester, NY (US)

Correspondence Address: GRAY CARY WARE & FREIDENRICH LLP, 2000 UNIVERSITY AVENUE, E. PALO ALTO, CA, 94303-2248, US

(21) Appl. No.: 10/346,457

(22) Filed: Jan. 15, 2003

(51) Int. Cl. B05D 1/36; B05D 3/02

(52) U.S. Cl. 427/404; 427/383.1; 427/524

(57) ABSTRACT

A method for preparing a noble metal surface on an industrial substrate for interaction with an organic material. The method includes covering the substrate with a sequence of metal layers which may include one or more adhesion layers, one or more diffusion barriers, and ends with a noble metal layer. In an optional second step, the noble metal layer may be annealed in order to stabilize its crystal structure. Finally, the noble metal layer is subjected to one or more ion bombardment steps, which are effective to clean and precisely smooth the top surface of the noble metal layer.

### FIELD OF THE INVENTION

This invention generally relates to the controlled preparation of noble metal surfaces at the atomic level, and more particularly, to a method for cleaning and smoothing noble metal surfaces on an atomic scale with the intent of manipulating the interaction between these surfaces and organic molecules.

### BACKGROUND OF THE INVENTION

The atomic level interaction between noble metal surfaces such as Au(111) or Ag(111) and organic molecules is important in number of biotechnological and electronic applications. Examples of such applications include the use of sputtered Ag films as anti-microbial films (see e.g., U.S. Pat. No. 5,837,275 of Burrell et al.); the use of Au(111) films as a seed layer for self-assembled monolayers in selective DNA detection (see e.g., E. Huang, et al., “Studies of surface coverage and Orientation of DNA Molecules Immobilized onto Preformed Alkanethiol Self-assemble Monolayers,” Langmuir, vol. 16, p. 3272 (2000), and U.S. Pat. No. 5,472,881 of Beebe, et al. (“Beebe, et al.”)); and the use of Ag or Au films as substrates/electrodes for nanotubes and other organic electronic devices (see e.g., U.S. Pat. No. 6,231,983 of Lee, et al.).

In all these applications, the interaction between the organic molecules and the metallic film is determined by the details of the metal surface, i.e., the atomic scale surface morphology (e.g., steps and kinks) as well as the surface composition. Prior art applications employ a variety of surface preparation methods, which intend to generate a clean noble metal surface with atomic level smoothness for use in such applications.

For example, Beebe, et al. describes a sequence for preparation of Au(111) single crystals, including the following steps:

1) Mechanical polishing with successive smaller Alumina or diamond grit;

2) Electropolishing;

3) Cleaning by cycles of Ar sputtering (500 eV);

4) Annealing under vacuum (500° C.);

5) Flame annealing with a Bunsen burner; and

6) Quenching in methanol.

Another method, sometimes referred to as the “replica technique,” is described in Samori et al., Langmuir, vol. 15, p. 2592 (1999), and includes the following steps:

1) Evaporation of a Au film on a freshly cleaned Mica crystal;

2) Electroplating of 200 μm Ni; and

3) Dissolution or mechanical removal of the Mica to form a Template-Stripped Gold (TSG) structure.

Yet another method is described in Kirakosian et al., J. Appl. Phys., vol. 90, p. 3286 (2001), and includes the following steps:

1) Formation of an atomically clean miscut Si(111) single crystal with atomically flat terraces in an Ultra High Vacuum (UHV) chamber, including a 1050° C. anneal step; and

2) Evaporation of a Ti seed layer and a Au layer.

While the foregoing methods have provided clean noble metal surfaces in a laboratory environment, they have significant disadvantages. Particularly, the foregoing methods are not adapted for low cost manufacturing on a wafer level, and are incompatible with standard MEMS or backend CMOS processing for integrated biosensors and chips.

An example of a device that includes organic material attached to a noble metal surface is described in U.S. Pat. No. 6,406,921 of Wagner et al. (“Wagner et al.”). Wagner et al. describes a wafer containing an array of noble metal patches, which consist of a noble metal layer (such as a gold layer) deposited on an adhesion layer (such as a titanium layer). Organic molecules are arranged on top of the noble metal surface. FIG. 1 illustrates an example of such a device 10, including a substrate 12, a noble metal layer 16 which is coupled to the substrate 12 by use of an adhesion layer 14, and a plurality of organic molecules 18, which are coupled to the top surface of the noble metal layer 16. Wagner et al. suggests that it is desirable to have atomically smooth surfaces (i.e., that the top surface of the noble metal layer 16 be precisely flat), but fails to disclose or suggest any method that would allow such surfaces to be realized on the top of a film.

Another example is described by F. Hofmann et al. in “Fully Electronic DNA Detection on a CMOS Chip: Device and Process Issues,” Proc. of IEDM (2002). These authors describe fabrication and testing of a DNA recognition chip, based on an electrical detection scheme. The contact electrodes are 50 nm Ti/50 nm Pt/500 nm Au stacks. The authors mention that the integrated chip requires a high temperature forming gas anneal step (e.g., 350-400° C.). It is reported that during that step, the gold films recrystallize, leading to a roughening of their surface, especially after the 400° C. anneal.

There is therefore a need for an improved method for preparing a noble metal surface, which is adapted to optimize the surface for interaction with organic molecules, which provides a simple cost-effective method to manipulate the morphology of the noble metal surface on an atomic scale, which can be integrated with standard thin film technology, and which may be used in biotechnological and electronic applications.

### SUMMARY OF THE INVENTION

The present invention provides a method for preparing a noble metal surface, such as a Au(111) or Ag(111) surface, on an industrial substrate such as a Si/SiO₂ wafer. In one embodiment, the method includes three steps. Particularly, the method may be performed in the following manner: (i) in a first step, the substrate may be covered by a sequence of metal layers which may include one or more adhesion layers, one or more diffusion barriers, and one or more noble metal layers; (ii) in an optional second step, the noble metal layer may be annealed in order to stabilize its crystal structure; and (iii) in a third step, the noble metal layer may be subjected to a sequence of ion bombardment steps, which involve one or more cleaning steps, as well as one or more smoothing steps.

One non-limiting advantage of the present invention is that it provides a method for preparing a noble metal surface, which is adapted to optimize the surface for interaction with organic molecules.

Another non-limiting advantage of the present invention is that it provides a simple, cost-effective method to manipulate the morphology of noble metal surfaces on an atomic scale.

Another non-limiting advantage of the present invention is that it provides a method for preparing noble metal surfaces on substrates for stand-alone or integrated application in microelectronic systems, microelectromechanical systems (MEMS), such as an atomic force microscope, or microopticalelectromechanical systems (MOEMS), such as interferometers for microfluidic cytometry.

According to a first aspect of the present invention, a method is provided for preparing a noble metal surface for interaction with an organic material. The method includes the steps of: a) providing a substrate; b) depositing a multilayer material on the substrate, including a top noble metal layer; and c) bombarding a top surface of the noble metal layer with ions, effective to precisely smooth the top surface.

According to a second aspect of the present invention, a method is provided for preparing a noble metal surface on a substrate for interaction with an organic material. The method includes the steps of: depositing a multilayer material on the substrate, including a top noble metal layer, at least one adhesion layer, and at least one diffusion barrier layer (the adhesion and barrier layers may be combined, graded or sandwiched); annealing the noble metal layer; and exposing a top surface of the noble metal layer to ion bombardment, effective to precisely smooth the top surface.

These and other features, aspects and advantages of the invention will become apparent by reference to the following specification and by reference to the following drawings.

### BRIEF DESCRIPTION OF THE DRAWINGS

FIG. 1 is a schematic sectional view of a prior art device including a wafer with a noble metal surface and organic material attached to the surface.

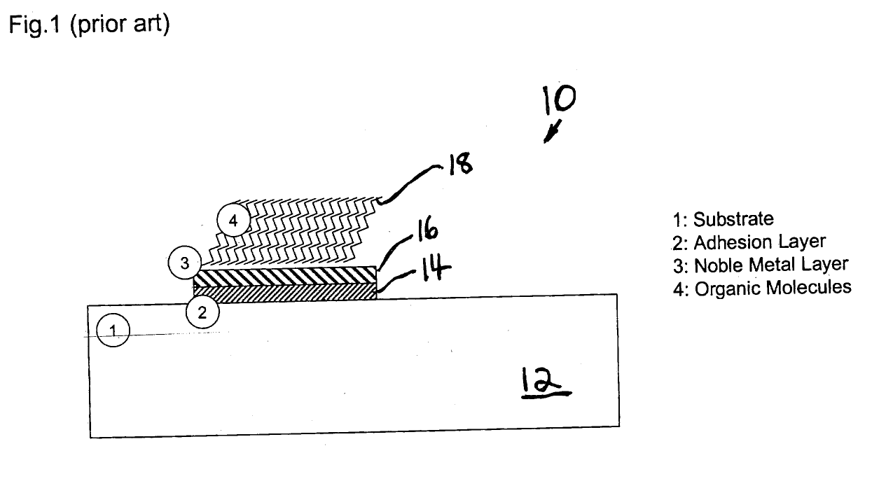

FIG. 2 is a flow chart illustrating a method for preparing a noble metal surface, according to one embodiment of the present invention.

FIG. 3 is a schematic sectional view of a device formed after performing a first step of the method shown in FIG. 2.

FIG. 4 is a graph illustrating the results of X-ray diffraction of a TiW/TiWN/TiW/Au multi-layer film.

FIG. 5 is a schematic sectional view of a device formed after performing a second step of the method shown in FIG. 2.

FIG. 6 is a schematic sectional view of a device undergoing a third step of the method shown in FIG. 2.

### DETAILED DESCRIPTION OF THE EMBODIMENTS

The present invention will now be described in detail with reference to the drawings, which are provided as illustrative examples of the invention so as to enable those skilled in the art to practice the invention. The present method may apply to the preparation of noble metal surfaces on substrates for stand-alone or integrated application in microelectronic systems, microelectromechanical (MEMS) systems (e.g., an atomic force microscope), and/or microopticalelectromechanical systems (MOEMS) (e.g., interferometers for microfluidic cytometry).

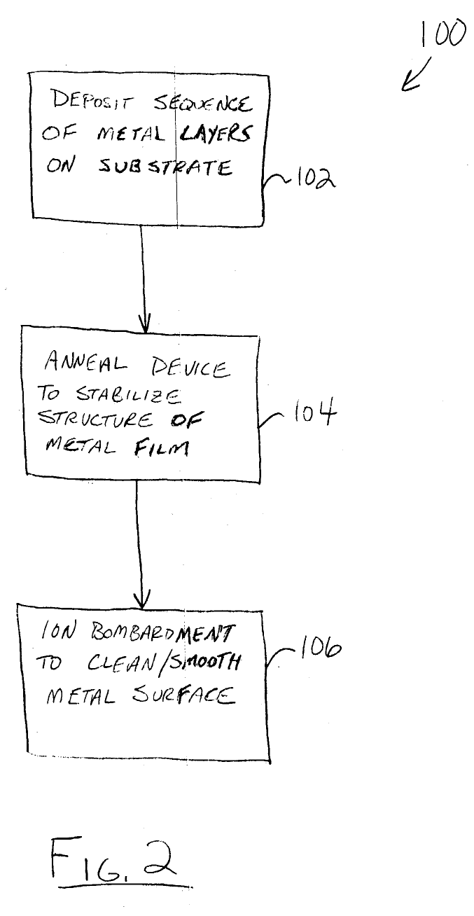

FIG. 2 illustrates a general methodology 100 for preparing noble metal surfaces, according to one embodiment of the present invention. The method may include three steps 102, 104 and 106. In step 102, a substrate is covered by a sequence of metal layers, which may include one or more adhesion layers, one or more diffusion barriers, and one or more noble metal layers. In step 104, which is an optional step, the device may be annealed in order to stabilize the crystal structure of the noble metal layer. In step 106, the substrate may be subjected to a sequence of ion bombardment steps, which involve one or more cleaning steps, as well as one or more smoothing steps. Each of these steps is described more fully and completely below.

Step 1: Multi-layer Film Deposition

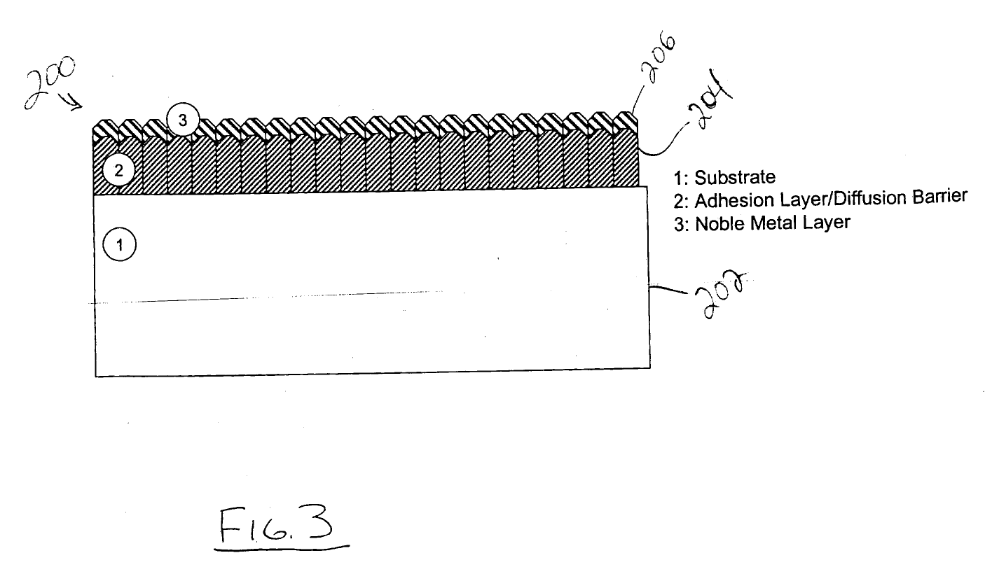

The first step of the method 100 (e.g., step 102 in FIG. 2) is to deposit a multilayer material or stack on a substrate. The multilayer may comprise one or more adhesion, seed and/or diffusion barrier layers, and a top noble metal layer. FIG. 3 illustrates the structure of a device 200 formed after this first step. Particularly, the device 200 includes a substrate 202, one or more adhesion/diffusion barriers 204 (the adhesion and barrier layers may be combined, graded and/or sandwiched), and a top noble metal layer 206. Such a multilayer structure (i.e., layers 204 and 206) can be deposited by any suitable manner, such as but not limited to Physical Vapor Deposition (PVD), Chemical Vapor Deposition (CVD), Ion Beam Deposition (IBD), Atomic Layer Deposition (ALD) or evaporation. Some examples of suitable, known multilayers that may be deposited include a TiW/TiW(N)/TiW/Au multilayer (see e.g., U.S. Pat. No. 5,173,449 of Lorenzen et al. (“Lorenzen et al.”), which is incorporated herein by reference), a TiW/Ta/Au multilayer (see e.g., U.S. Pat. No. 4,300,149 of Howard et al. (“Howard et al.”), which is incorporated herein by reference), and a TiN/Ti/TiN/Pt multilayer (see e.g., U.S. Pat. No. 3,798,145 of Fournier (“Fournier”), which is incorporated herein by reference). These metallization schemes or multilayers are well known to be compatible with semiconductor processing, and are effective to prevent the electrically active noble metal atoms from reaching the semiconductor active areas (e.g., the diffusion barrier structure survives hundreds of hours at temperatures above 400° C.). These schemes are also known to be suitable for use in conjunction with an industrial substrate such as a glass wafer, a Si MEMS device wafer, or a Si wafer containing CMOS devices. The films can be deposited in a low cost, high volume manufacturing environment.

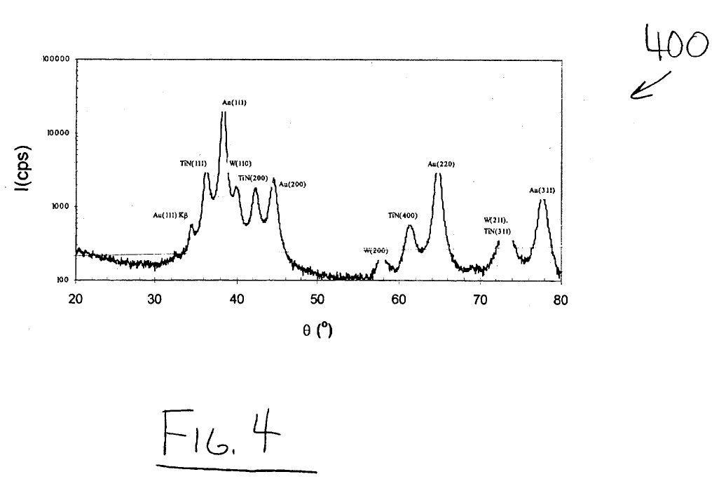

It has been shown that it is possible to obtain textured polycrystalline noble metal films in such a multilayer structure. This is illustrated in graph 400 of FIG. 4, which shows an X-ray diffraction measurement on a multilayer structure including the following layers (listed from bottom to top): 450 Å TiW, 1800 Å TiWN, 250 Å TiW, and 500 Å Au deposited by Physical Vapor Deposition (PVD) on a substrate at room temperature. A strong (111) texture was observed in the Au film, along with grain sizes of the order of 200 Å. The grain size of the film may be enhanced by performing the deposition at a higher substrate temperature. The roughness of the surface depends on the exact deposition conditions, and the thickness and nature of the underlayers and substrate. A typical value of the Root-Mean-Square (R_{RMS}) roughness amplitude for a polycrystalline noble metal film in a multilayer structure is approximately 15 Å. This roughness is associated with grain size in the thick diffusion barrier.

When comparing these microstructure values to an optimized surface prepared using the replica technique (see e.g., Fournier), it is apparent that the grain size is quite comparable to the grain sizes obtained at room temperature, but the roughness is about a factor of 3 higher in the films created at this step of the present method. Therefore, it is desirable to smooth the surface of the films to an approximate R_{RMS}=5 Å level prior to application of the organic molecules. This may be achieved by the subsequent smooth steps. It should be appreciated that the smooth steps do not necessarily have to be performed immediately after the deposition step, but that several intermediate, unrelated process steps might separate them.

Step 2 (optional): Annealing

One intermediate step that may be performed is an annealing step (e.g., step 104 in FIG. 2) to stabilize the crystal structure of the noble metal film. Gold and silver films have a relatively low melting point, and therefore, their atomic level film microstructure is not stable under mild thermal cycling. For example, the film microstructure may become unstable when annealing at a relatively low annealing temperature (e.g., temperatures below 200° C.) for a few hours. A well-known method to stabilize the structure is to anneal at a relatively high annealing temperature (e.g., at 400° C. for one hour). An additional advantage of this annealing step is that it can lead to an enlargement of the grains in the noble metal film.

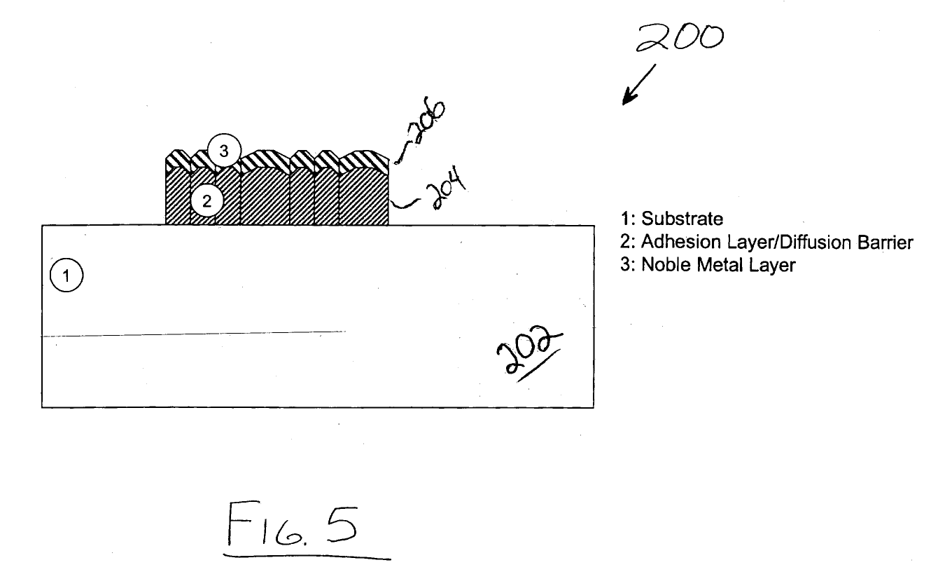

During the annealing step, it is desirable to ensure that the diffusion barrier 204 does not leak. This is especially important for the case of gold films on silicon surfaces, since gold and silicon form a eutectic at 390° C., and contact between these materials at these temperatures may lead to liquefaction and destruction of the device. FIG. 5 shows a schematic of the device structure 200 after completion of the annealing step.

It should be noted that some cleaning may be achieved in during the annealing step by performing the annealing in a vacuum or other controlled atmosphere, such that contamination from the surface is either evaporated off of the surface or undergoes a chemical reaction so that it is easier to remove.

It should be appreciated that it is not necessary to perform the foregoing steps sequentially. In fact, between step 1 and step 3, several other steps, such as patterning steps, as well as other depositions may also be performed.

Step 3: Cleaning and smoothing by Ion Bombardment

In the preferred embodiment, the third step (i.e., step 106 in FIG. 2) may include a sequence of ion bombardment steps, which are effective to clean and smooth the noble metal surface on an atomic scale. This third step is preferably performed under vacuum conditions. Prior to this vacuum step, in some embodiments, the device may be exposed to one or more ex-situ steps, such as a particle removal step (e.g., by an exposure to a CO₂-jet).

The subsequent cleaning and smoothing by exposure to ion bombardment may preferably be performed in the same vacuum run. The two main steps are a cleaning step and a smoothing step.

1) Cleaning Step:

The purpose of the cleaning step is to obtain an atomically clean noble metal surface. The cleaning step is optional. Particularly, whether this step is needed or desirable may depend on the specifics of prior processing, such as the degree of exposure to photoresist or developer materials.

The use of plasma-based cleaning steps (sometimes referred to as “Plasma Descum”) to clean metal and other surfaces is well-known in thin film technology. The present invention may use several practical examples described in the literature. For example, the following known plasma cleaning methods may be used during the cleaning step:

(i) Exposure to an oxygen plasma in a Reactive-Ion Etch (RIE) reactor may be used to remove a carbon-based contamination (photoresist residue). One such process is described in Liu, Vasile and Beebe, “The Fabrication of Nonplanar Spin-On Glass Microstructures,” J.MEMS, vol. 8, no. 2 (June 1999).

(ii) A remote inductively coupled hydrogen plasma may be used to clean an oxide layer. This type of cleaning process is described in Park and Rhee, “Effect of hydrogen plasma precleaning on the removal of interfacial amorphous layer in the chemical vapor deposition of microcrystalline silicon films on silicon oxide surface,” Appl. Phys. Lett. 68, (Apr. 15, 1996)).

(iii) An inert, noble or reducing plasma may be used to clean a surface prior to physical vapor deposition of a film. One such method is described in U.S. Pat. No. 6,187,682 of Denning et al.

The cleaning step in the present invention may involve the following sub-steps:

1a) Carbon removal: In this sub-step, the noble metal surface of the device may be exposed to an oxygen-containing plasma, monomer or cluster ion beam, which may be effective to remove organic films. The oxygen can be provided in a variety of means, based on gases such as O₂, O₂/Ar, N₂O, O₃, and the like. This sub-step may generally leave a thin oxide film at the surface of the noble metal. In one embodiment, the cleaning method (i) described above may be used in this sub-step.

1b) Oxide Removal: In this sub-step, a thin oxide film that may result from sub-step 1a) may be easily removed by subsequent exposure to a noble gas or hydrogen-based plasma or ion beam. This treatment also leaves the noble metal (e.g., gold) surface hydrophilic. In one embodiment, the cleaning method (ii) described above may be used in this sub-step.

1c) Final Cleanup: In this sub-step, other contaminants such as Sulfur or Chlorine can be removed by a short sputter etch step using noble gas (e.g., Ar, Xe, Ne) plasma, monomer ion or cluster ion beam. In one embodiment, the cleaning method (iii) described above may be used in this sub-step.

2) Smoothing Step

In the smoothing step, the surface morphology of the noble metal layer 206 is adjusted by the use of a low energy noble gas monomer or cluster ion beam. Various methods can be used to perform this smoothing step. Two non-limiting methods are described below:

2a) Ion Beam Polishing and/or Ion Beam Smoothing

In this method, the noble metal surface is exposed to ion bombardments at relatively low energies and appropriate angles of incidence. The specific energies and angles of incidence have been described in co-pending U.S. patent application Ser. No. 10/159,134, which has been assigned to the present assignee and which is fully and completely incorporated herein by reference. The foregoing patent application illustrates that it is possible to smoothen polycrystalline Cu films to desired roughness levels of less than 5 Å R_{RMS} by exposing the clean metal surface to a low energy ion beam, whereby the angle and energy of the ions are within a certain range. It has been shown that for very low ion energies (e.g., less than 50 eV), Cu and Ag surfaces could be smoothed effectively by ions with near normal incidence without etching the surface. With Au surfaces, it has been found that off-angle bombardment with higher ion energies is desirable. This type of smoothing process may involve some amount of etching of the Au surface, which is acceptable for the intended applications.

Depending on whether it is effective to obtain efficient smoothing for the particular noble metal concerned (e.g., Ag, Au, Cu, Ni, Pt, Ru, Rh, Pd, Re and their alloys), one or two types of apparatus may be used to perform the previously described cleaning step and the smoothing step.

In the case where it is difficult to obtain effective smoothing at normal ion incidence angles, one can use an apparatus having a broad beam ion source, such as that described in U.S. Pat. No. 3,156,090 of Kaufman. The ion source may be mounted in a conventional manner at the appropriate angle to the substrate normal. Noble gas ions may then be extracted from the source and accelerated to the appropriate energy as discussed in U.S. patent application Ser. No. 10/159,134 (e.g., 100 eV Ar ions at 70° off-normal).

As described in that application, the smoothing efficiency at normal incidence decreases significantly if the projectile mass is much lower than the target mass. In the case of gold films, only Radon and Xenon ions are close in mass. However, both gases are more rare than Argon and therefore considerably more expensive. Furthermore, Radon is radioactive, which may lead to safety-related complications during handling and storage. Therefore, one might opt to use off-angle smoothing at higher energies in such case. The ion incidence angle and energy can be made variable for maximal flexibility.

In the case where effective smoothing occurs upon bombardment at normal incidence, one could alternatively use an additional type of apparatus for the smoothing step (and for the cleaning step, as well). In this case, it is possible to expose the substrate to a plasma step in a parallel plate plasma accelerator, an inductively coupled plasma (ICP) unit (see e.g., U.S. Pat. No. 4,948,458 of Ogle, which is fully and completely incorporated by reference), or an electron cyclotron resonance (ECR) plasma reactor, leading to normal incidence ion bombardment. The ion energy may be varied by the pressure and power of the plasma as will be appreciated to those skilled in the art.

2b) Gas Cluster Ion Beam Apparatus

Alternatively, the smoothing step may be performed using a gas cluster ion beam apparatus (see e.g., U.S. Pat. No. 5,459,326 of Yamada and/or U.S. Pat. No. 6,375,790 of Fenner, which are both fully and completely incorporated herein by reference). It is well-known that a gas cluster ion beam (GCIB) apparatus may be used to reduce the roughness of polycrystalline films to the desired level. It is possible to perform the cleaning and smoothing steps in a single vacuum run in a GCIB apparatus by performing a sequence of bombardments. For example, the first cleaning step may contain clusters based on an Ar/O₂ gas mixture, and the subsequent smoothing step may contain pure noble gas clusters, e.g., Ar-based clusters. The energy of the ions can also be adjusted to obtain the desired level of final roughness, as will be appreciated to those skilled in the art.

The operating conditions used to perform such a smoothing process with an GCIB apparatus are known in the art. One example of typical operating conditions for such a process are described in Allen et al. “Substrate Smoothing Using Gas Cluster Ion Beam Processing,” JEM. vol. 30, no. 7, p. 829 (July 2001). The gas cluster ion beam may be formed in an apparatus which is commercially available from Epion Corporation of Billerica, Mass. The adiabatic expansion parameters may be selected in a known manner such that they yield gas clusters in the range of 500 to 5000 individual atoms, and acceleration energies in the range of a few keV. The ions are incident upon the substrate along the normal. It has been shown that such a bombardment can lead to reduction of the surface roughness to the range of interest.

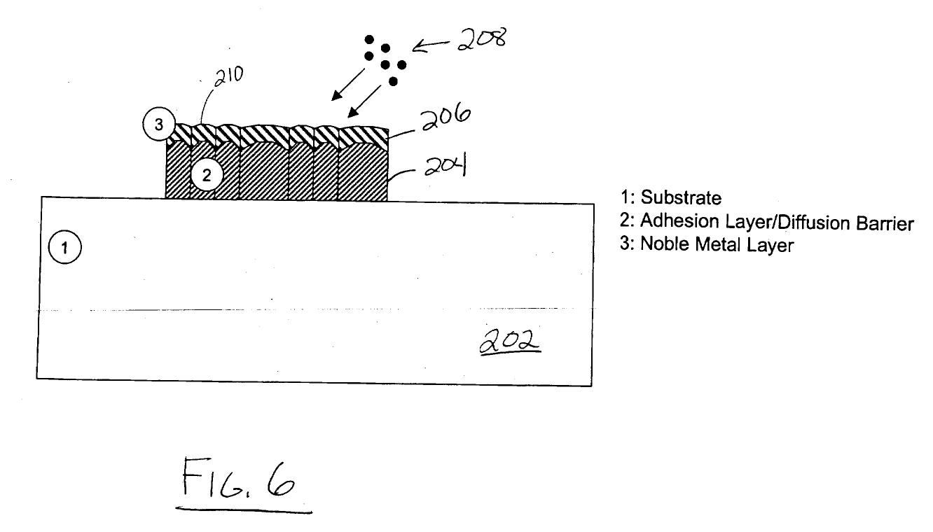

FIG. 6 shows one embodiment of the smoothing step, which illustrates particles 208 bombarding the surface 210 of noble metal layer 206. After the smoothing step is completed, the surface 210 is precisely flat and ready for exposure to the organic molecules. Organic molecules may be added or coupled to the surface in a conventional manner to create an integrated device, such as an atomic force microscope for analyzing the organic material.

It should be appreciated that the foregoing method provides a simple, cost-effective method for manipulating noble metal surfaces on an atomic scale. Particularly, the foregoing method allows a noble metal surface to be prepared in a manner which optimizes the surface for interaction with organic molecules. In this manner, the method may be used to prepare noble metal surfaces on substrates for stand-alone or integrated application in a microelectronic systems, microelectromechanical systems (MEMS), or microopticalelectromechanical systems (MOEMS).

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. A method for preparing a noble metal surface for interaction with an organic material, the method comprising the steps of:
a) providing a substrate;
b) depositing a multilayer material on the substrate, including a top noble metal layer; and
c) bombarding a top surface of the noble metal layer with ions, effective to precisely smooth the top surface.

2. The method of claim 1 further comprising the step of:
annealing the noble metal layer.

3. The method of claim 2 wherein the step of annealing the noble metal layer is performed after step b) and before step c).

4. The method of claim 2 wherein the noble metal layer is annealed at a relatively high temperature.

5. The method of claim 1 wherein the multilayer material includes a diffusion barrier layer.

6. The method of claim 5 wherein the multilayer material further includes an adhesion layer.

7. The method of claim 6 wherein the multilayer material further includes a seed layer.

8. The method of claim 1 further comprising the step of cleaning the top surface of the noble metal layer.

9. The method of claim 8 wherein the step of cleaning the top surface of the noble metal layer is performed before step c).

10. The method of claim 9 wherein the step of cleaning the top surface of the noble metal layer includes the following sub-steps:
a carbon removal process;
an oxide removal process; and
a final cleaning process.

11. The method of claim 1 wherein step c) includes bombarding the top surface of the noble metal layer with ions having relatively low energies at near normal incidence angles.

12. The method of claim 1 wherein step c) is performed in a gas cluster ion beam apparatus.

13. The method of claim 1 wherein step c) is performed under vacuum conditions.

14. A method for preparing a noble metal surface on a substrate for interaction with an organic material, the method comprising the steps of:
depositing a multilayer material on the substrate, including a top noble metal layer, at least one adhesion layer, and at least one diffusion barrier layer;
annealing the noble metal layer; and
exposing a top surface of the noble metal layer to ion bombardment, effective to precisely smooth the top surface.

15. The method of claim 14 wherein the noble metal layer is annealed at a relatively high temperature.

16. The method of claim 14 wherein the multilayer material further includes at least one seed layer.

17. The method of claim 14 further comprising the step of cleaning the top surface of the noble metal layer.

18. The method of claim 17 wherein the step of cleaning the top surface of the noble metal layer is performed before exposing the top surface to ion bombardment.

19. The method of claim 17 wherein the step of cleaning the top surface of the noble metal layer includes the following sub-steps:
a carbon removal process;
an oxide removal process; and
a final cleaning process.

20. The method of claim 14 wherein the top surface of the noble metal layer is bombarded with ions having relatively low energies at near normal incidence angles.
